(19) United States
(12) Patent Application Publication
(10) Pub. No.: US 2025/0259834 A1
(43) Pub. Date: Aug. 14, 2025

(54) METHOD FOR SIMULTANEOUS AND RAPID DETERMINATION OF CHLORINE, BROMINE AND IODINE BY PYROHYDROLYSIS COMBINED WITH ICP-MS

(71) Applicant: BGRIMM MTC TECHNOLOGY CO., LTD., Beijing (CN)

(72) Inventors: Yehong Shi, Beijing (CN); Jialiang Sun, Beijing (CN); Fei Yang, Beijing (CN); Pengcheng Han, Beijing (CN); Zhen Zhao, Beijing (CN); Huachang Li, Beijing (CN); Shengnan Fang, Beijing (CN); Bicong Xu, Beijing (CN); Xuan Wang, Beijing (CN)

(21) Appl. No.: 18/261,514

(22) PCT Filed: Jun. 5, 2023
(86) PCT No.: PCT/CN2023/098286

§ 371 Date: Oct. 11, 2024

(30) Foreign Application Priority Data
Oct. 11, 2022 (CN) 202211237674.4

(51) Int. Cl. H01J 49/04; H01J 49/10

(52) U.S. Cl. CPC H01J 49/0477; H01J 49/105

(57) ABSTRACT

The present invention belongs to the technical field of Cl, Br and I detection, comprising: (1) placing a substance to be determined in a sample container, laying asbestos on the surface of the substance to be determined and then conducting pyrohydrolysis treatment: firstly, optionally, preheating for 3-10 min at 500-600° C., heating for 3-10 min at 700-800° C., and then burning for 10-30 min at 1000-1100° C.; (2) obtaining the standard curves of the corresponding concentration value and the net strength value of each element; and (3) testing the net strength of the liquid in step (1) using ICP-MS combined with an online internal standard method, and combining with the standard curves to obtain the contents of chlorine, bromine and iodine in the substance to be determined. The method of the present invention can avoid a deflagration phenomenon, is simple, rapid and high in detection accuracy.

### TECHNICAL FIELD

The present invention belongs to the technical field of Cl, Br and I detection, and particularly relates to a method for simultaneous and rapid determination of chlorine, bromine and iodine by pyrohydrolysis combined with ICP-MS.

### BACKGROUND

Chlorine, bromine and iodine are closely related to human health conditions and are of great significance in environmental research. For example, chlorine is a necessary nutrient element in the growth process of animals and plants, and excessive or insufficient intake may cause poor growth of animals and plants. The content of bromine in a human body can affect the metabolism of iodine, thereby affecting the health of the body. The intake of massive bromine may reduce the accumulation of iodine in thyroid and mammary gland and aggravate the loss of iodine in the kidneys. Iodine participates in the synthesis of thyroxine in the human body and plays an important role in the development of the human body and the brain. Bromine and iodine are also important indicators of the evolution process of the earth and are often used for exploring paleoenvironmental reconstruction and rock metamorphism history. Chlorine, bromine and iodine in the atmospheric environment can also destroy the ozone layer, thereby affecting global climate change. Because the halogens in the environment are low in content, highly volatile and highly interfered, it is of important significance to accurately determine the halogen content in different substrates to evaluate the environmental effects of the halogens.

At present, the frequently-used methods for determining chlorine, bromine and iodine include spectrophotometry, ion chromatography, ion selective electrode and ICP-MS. The spectrophotometry requires manual operation, has complicated steps and high professional requirements for experimenters, and cannot simultaneously determine more than two elements; and the ion chromatography and the ion selective electrode have the problems of high detection limit and low sensitivity in the determination of chlorine, bromine and iodine. As a frequently-used means for the determination of inorganic ions in solutions, ICP-MS, has high sensitivity, low detection limit and good stability, can simultaneously detect many elements and is widely used in the field of chemical detection.

Traditional pretreatment methods for separating and collecting chlorine, bromine and iodine from complex substrates include acid fusion, alkaline fusion, microwave digestion and pyrohydrolysis. Acid fusion and alkaline fusion methods use the acid-base differences of each determined component in the complex substrates for separation, require manual operation by the experimenters and long time, use a large number of acid and alkali reagents in the detection process and cause certain pollution to the environment. The microwave digestion technology uses microwaves for heating reagents and samples in a closed container, and quickly dissolves the samples under high temperature pressurization conditions. Because interference elements are easy to be introduced into a digestion solution and a microwave digestion instrument is expensive, requirements for the experimental conditions are high. Pyrohydrolysis is a hydrolysis reaction between the sample and vapor under high temperature conditions, in which the halide is converted into halogen acid which is dissolved in an absorption solution. Pyrohydrolysis can treat inorganic samples and organic samples, may not introduce interference components, and is widely used in halogen detection.

CN108802156B discloses a method for determining iodine content in coal. A specific treatment process is: heating at 300, 600 and 800° C. for 5 min, and heating at 1400-1500° C. for 10-20 min; oxygen flow of 0.15-0.2 L/min and vapor of 0.5-1 L/min; absorption by 0.1 mol % NaOH; and then detection.

CN105675698A discloses a method for determining Br in coal. A specific treatment process is: heating and holding at 1050-1150° C. for 20-30 min, oxygen of 0.18-0.22 L/min, vapor of 0.8-1.2 mL/min; absorption by 10 g/L NaOH; and then detection.

The above prior arts use pyrohydrolysis for sample treatment. CN108802156B grinds an experimental sample into 100 meshes and mixes the sample with quartz sand for combustion. However, quartz sand particles are easy to be blown by a carrier airflow or some samples are violently burned and splashed in the process of experiments, causing that the samples remain in a combustion tube, thereby affecting the smooth sampling of a sample boat. CN105675698A crushes the sample into 200 meshes for direct combustion, but the detection accuracy of the two methods needs to be further improved. In addition, in CN105675698A, coal samples may generate a deflagration phenomenon during combustion. Moreover, the detection method selects the method of ion selective electrode. This method needs to adjust the pH value of the absorption solution after pyrohydrolysis, is complicated in operation and high in detection limit, and cannot detect of iodine with low content. Moreover, the content of one type of ion is detected only.

### SUMMARY

The purpose of the present invention is to overcome the defects of deflagration in combustion, low detection accuracy, complicated operation and high detection limit in the prior art, to provide a method for simultaneous and rapid determination of chlorine, bromine and iodine by pyrohydrolysis combined with ICP-MS. The method can avoid a deflagration phenomenon, is simple, rapid and environmentally-friendly in operation and high in detection accuracy, and can simultaneously and rapidly detect the contents of trace chlorine, bromine and iodine in a substance to be determined. The detection limit of the method is much lower than those of detection methods such as an ion selective electrode method, ion chromatography and colorimetry.

To achieve the above purpose, the present invention proposes a method for simultaneous and rapid determination of chlorine, bromine and iodine by pyrohydrolysis combined with ICP-MS, comprising the following steps:
(1) placing a substance to be determined in a sample container, laying asbestos on the surface of the substance to be determined and then conducting pyrohydrolysis treatment;
wherein the process of the pyrohydrolysis treatment comprises: firstly, optionally, preheating for 3-10 min at 500-600° C., then heating for 3-10 min at 700-800° C. to burn off organic matter in the substance to be determined, and then burning for 10-30 min at 1000-1100° C.;
(2) preparing a standard curve solution and an internal standard solution of serial concentrations, and testing net strength using an ICP-MS instrument combined with an online internal standard method to obtain the standard curves of the corresponding concentration value and the net strength value of each element;
(3) testing the net strength of the liquid obtained in step (1) using the ICP-MS instrument combined with the online internal standard method, combining with the standard curves to obtain the concentrations of chlorine, bromine and iodine in the liquid, and further obtaining the contents of chlorine, bromine and iodine in the substance to be determined.

In some preferred embodiments of the present invention, the method further comprises: conducting pyrohydrolysis pretreatment for the sample container and the asbestos before step (1).

More preferably, the process of the pyrohydrolysis pretreatment comprises: burning for 5-10 min at 1000-1100° C.

In some preferred embodiments of the present invention, the conditions of the pyrohydrolysis treatment or the pyrohydrolysis pretreatment comprise:
the oxygen flow of an inner tube of a combustion tube is 50-100 mL/min, the oxygen flow of an outer tube of the combustion tube is 50-200 mL/min, and the oxygen flow of blown cracking water is 50-200 mL/min; and a final constant volume is 10-50 mL, comprising 3-10 mL of absorption solution, 4-30 mL of cracking water and 3-10 mL of cleaning solution.

Preferably, the absorption solution and the cleaning solution are both aqueous ammonia with a mass concentration of 0.1-1%.

Preferably, the cracking water is I-grade experimental water.

In some preferred embodiments of the present invention, the workstation tuning parameters of the ICP-MS instrument in step (2) and step (3) are set as follows:
Re>2000;
In>40000;
U>30000;
CeO/Ce≤0.025;
Ce++/Ce≤0.04.

In some preferred embodiments of the present invention, the experimental parameters of the ICP-MS instrument in step (2) and step (3) comprise:
instrument mode: standard mode;
radio frequency power: 1500W;
plasma gas flow: 18 L/min;
auxiliary gas flow: 1.2 L/min;
atomizer gas flow: 0.96 L/min;
number of test points: 3;
sampling cone: platinum cone;
detection mode: peak jumping;
internal standard substance: rhodium;
internal standard adding mode: online adding of the internal standard solution;
atomizing chamber rubber ring: fluororubber.

In some preferred embodiments of the present invention, the specific process of step (2) comprises:
(201) taking a chlorine single-element standard solution, a bromine single-element standard solution and an iodine single-element standard solution respectively, and preparing serial concentrations of standard curve solutions containing chlorine, bromine and iodine;
(202) taking the standard solution of an internal standard element and preparing an internal standard solution;
(203) injecting the serial concentrations of standard curve solutions into the ICP-MS instrument respectively, and determining the contents of chlorine, bromine and iodine using the internal standard solution by the online internal standard method to obtain the standard curves of the corresponding concentration value and the net strength value of each element.

In some preferred embodiments of the present invention, the internal standard element in the internal standard solution is rhodium, and/or the concentration of the internal standard element in the internal standard solution is 30-80 μg/L.

In some preferred embodiments of the present invention, the concentration of chlorine in the standard curve solution is 500 μg/L-3000 μg/L, the concentration of bromine is 0.5 μg/L-100 μg/L, and the concentration of iodine is 0.1 μg/L-100 μg/L.

The inventor of the present invention finds through research that, because an experimental sample, especially a biological sample, contains a large amount of organic matter and may produce deflagration accompanied by black small toner after direct combustion at 1000-1100° C., the interior of the combustion tube, an absorption bottle, a collection pipeline and a tested sample solution are polluted. Although the above CN108802156B and CN105675698A are pyrohydrolysis, the sample is blown up by oxygen during sampling in the combustion process, which will affect the experimental results and affect the detection accuracy.

By combining pyrohydrolysis with ICP-MS and matching with covering asbestos, heating and optional preheating, the present invention can prevent the phenomena of sample deflagration, splashing and blowing, and realizes rapid, accurate and stable determination of the contents of chlorine, bromine and iodine in different samples; and moreover, the present invention is simple, rapid and environmentally-friendly in operation and can simultaneously detect multiple halogens with lower content. The method of the present invention has the characteristics of simple operation, rapid determination speed, high sensitivity and low detection limit. Wherein in the pyrohydrolysis treatment, the heating and optional preheating can be used for eliminating the phenomenon of sample deflagration, and the sample surface is covered with a layer of asbestos, which effectively prevents the small powder sample from being blown up by oxygen in the sampling process and prevents solid particles generated in the combustion process of the sample from polluting the pipeline.

The method of the present invention can simultaneously detect trace chlorine, bromine and iodine in soil, water sediment, rock and biological samples, and the detection limit of the method is much lower than those of detection methods such as an ion selective electrode method, ion chromatography and colorimetry. The detection range of the method of the present invention for Br detection is 0.5 μg/L-100 μg/L, the detection limit is 0.12 μg/L, and the limit of quantitation is 0.082 μg/g. The detection range for I detection is 0.1 μg/L-100 μg/L, the detection limit is 0.03 μg/L, and the limit of quantitation is 0.022 μg/g. The detection range for Cl detection is 500 μg/L-3000 μg/L, the detection limit is 24.93 μg/L, and the limit of quantitation is 16.26 μg/g. The present invention is suitable for trace analysis and ultratrace analysis.

The inventor of the present invention finds through further research that the sample container and the asbestos contain Cl, Br and I to different degrees, which affects the accuracy of detection. For this, in the preferred solution of the present invention, the sample container (such as a new sample boat) and the asbestos are subjected to pyrohydrolysis pretreatment; the contents of Cl, Br and I thereon is obviously decreased, and the background values are basically the same; impurities are eliminated; and then the sample is loaded for detection, which eliminates the interference factor of the impurities of the sample container and the asbestos, keeps the background values consistent and makes the results more accurate.

### DETAILED DESCRIPTION

The endpoints and any values of the ranges disclosed herein are not limited to the exact ranges or values, and these ranges or values shall be understood to contain values close to these ranges or values. For numeric ranges, the endpoint values of each range, the endpoint values of each range and individual point values, and the individual point values can be mutually combined to obtain one or more new numeric ranges, and these numeric ranges shall be deemed to be specifically disclosed herein.

The present invention provides a method for simultaneous and rapid determination of chlorine, bromine and iodine by pyrohydrolysis combined with ICP-MS, comprising the following steps:
(1) placing a substance to be determined in a sample container, laying asbestos on the surface of the substance to be determined and then conducting pyrohydrolysis treatment;
wherein the process of the pyrohydrolysis treatment comprises: firstly, optionally, preheating for 3-10 min at 500-600° C., then heating for 3-10 min at 700-800° C. to burn off organic matter in the substance to be determined, and then burning for 10-30 min at 1000-1100° C.; that is, on the basis of heating and combustion, preheating can be conducted or not conducted;
(2) preparing a standard curve solution and an internal standard solution of serial concentrations, and testing net strength using an ICP-MS instrument (i.e., inductively coupled plasma mass spectrometry instrument) combined with an online internal standard method to obtain the standard curves of the corresponding concentration value and the net strength value of each element;
(3) testing the net strength of the liquid obtained in step (1) using the ICP-MS instrument combined with the online internal standard method, combining with the standard curves to obtain the concentrations of chlorine, bromine and iodine in the liquid, and further obtaining the contents of chlorine, bromine and iodine in the substance to be determined.

It should be understood that the sample container of the present invention is a container suitable for the pyrohydrolysis treatment and capable of loading samples, such as a sample boat.

The inventor finds through research that, because an experimental sample (i.e., the substance to be determined), especially a biological sample, contains a large amount of organic matter and may produce deflagration accompanied by black small toner after direct combustion at 1000-1100° C., the interior of the combustion tube, an absorption bottle, a collection pipeline and a tested sample solution are polluted. For this, on the one hand, the present invention conducts heating at 700-800° C. before combustion, so that almost all the organic matter in the sample can be fully burned to eliminate the phenomenon of deflagration in combustion of the sample. However, if the heating is higher than 800° C., the phenomenon of deflagration is likely to occur and the combustion tube is polluted; and on the other hand, the asbestos is laid on the surface of the substance to be determined in the present invention, which can effectively prevent the small powder sample from being blown up by oxygen in the sampling process and can prevent solid particles generated in the combustion process of the sample from polluting the pipeline. Moreover, the asbestos is a silicate mineral product with high tensile strength, high flexibility, resistance to chemical and thermal erosion and electrical insulation, does not contain substances such as chlorine, bromine and iodine to be detected, and thus may not affect the detection results.

The temperature of combustion is 1000-1100° C., which can fully promote the hydrolysis reaction of multiple halogens and ensure the recovery rate.

The preheating is conducted for 3-10 min, such as 3, 4, 5, 6, 7, 8, 9 and 10 min. The heating is conducted for 3-10 min, such as 3, 4, 5, 6, 7, 8, 9 and 10 min. The burning is conducted for 10-30 min, such as 10, 12, 15, 17, 19, 20, 24, 26, 28 and 30 min.

In some preferred embodiments of the present invention, the conditions of the pyrohydrolysis treatment comprise: the oxygen flow of an inner tube of a combustion tube is 50-100 mL/min, the oxygen flow of an outer tube of the combustion tube is 50-200 mL/min, and the oxygen flow of blown cracking water is 50-200 mL/min. Under the preferred solution, the oxygen flow is suitable, which promotes the thorough absorption of the detected substance and is more conducive to accurate detection. Under the same conditions, if the oxygen flow is too small, the hydrolyzed gas product cannot be blown into the absorption bottle for absorption, and may be absorbed incompletely; and too little oxygen may make the sample oxidation incomplete, and the detected substance remains in the combustion tube, resulting in a low test value. If the oxygen flow is too large, the absorption may also be incomplete, and part of the detected substance will be discharged with the gas before fully absorbed by the absorption solution, so that the recovery rate is low, resulting in a low test value; and too large gas flow will make the solution in a collection bottle splashed.

In some preferred embodiments of the present invention, the conditions of the pyrohydrolysis treatment further comprise: a final constant volume is 10-50 mL, comprising 3-10 mL of absorption solution, 4-30 mL of cracking water and 3-10 mL of cleaning solution.

Preferably, the absorption solution and the cleaning solution are both aqueous ammonia with a mass concentration of 0.1-1%. Under the preferred solution, the effect of dilute aqueous ammonia is more stable, which can maximize the absorption effects (which can all reach about 100%) and makes the recovery rate of chlorine, bromine and iodine highest, which is more conducive to accurate detection. Moreover, the aqueous ammonia can avoid corroding the atomizing chamber (glass material) of the ICP-MS instrument. Under the same conditions, when the concentration of the aqueous ammonia is less than 0.1%, the absorption effect is poor, and the test value is low; and when the concentration of the aqueous ammonia is higher than 1%, there are corrosion and expansion effects on a nitrile-butadiene rubber ring in the atomizing chamber, which affects the service life of the instrument. The conventionally used NaOH solution is corrosive to the atomizing chamber of the ICP-MS instrument.

Preferably, the cracking water is I-grade experimental water.

In some preferred embodiments of the present invention, the method further comprises: conducting pyrohydrolysis pretreatment for the sample container and the asbestos before step (1). Under the preferred solution, halogen impurities on the sample container and the asbestos can be removed; the contents of Cl, Br and I are significantly reduced; and the background values are basically the same. In this way, the interference factor of the impurities in the sample container and the asbestos is eliminated, the background values are kept consistent, and the accuracy of chlorine, bromine and iodine in the substance to be determined is further improved. This is because the new boat or the sample boat is stored for a long time and the asbestos is stored in the air for a long time, which may adsorb certain halogen impurities, thereby affecting the detection accuracy. In some specific embodiments, taking the new sample boat as an example, the specific detection results before and after a pyrohydrolysis pretreatment (burning at 1100° C. for 5 min) are shown in Table 1 below. It can be seen from Table 1 that after pyrohydrolysis pretreatment, the contents of Cl, Br and I are decreased significantly, which can eliminate the interference factor of the impurities in the sample container and improve the detection accuracy.

TABLE 1

| | Br | I | Cl |
|---|---|---|---|
| | (ug/L) | (ug/L) | (ug/L) |
| No. of New | | | |
| Sample Boat | | | |
| 1 | 0.720 | 0.436 | 35.052 |
| 2 | 0.827 | 0.377 | 303.319 |
| 3 | 0.665 | 1.151 | 119.227 |
| 4 | 1.493 | 0.621 | 131.590 |
| 5 | 1.087 | 0.498 | 154.466 |
| 6 | 1.236 | 0.435 | 259.352 |
| No. of Sample | | | |
| Boat after a | | | |
| Pyrohydrolysis | | | |
| 1 | 0.165 | 0.248 | 37.940 |
| 2 | 0.191 | 0.295 | 11.862 |
| 3 | 0.169 | 0.193 | 23.863 |
| 4 | 0.225 | 0.183 | 35.668 |
| 5 | 0.187 | 0.229 | 29.381 |
| 6 | 0.204 | 0.271 | 42.315 |

More preferably, the process of the pyrohydrolysis pretreatment comprises: burning for 5-10 min at 1000-1100° C. After the pyrohydrolysis pretreatment is completed, the collected pretreatment solution can be directly discharged to a waste liquid bottle without detection.

In some specific embodiments, the process of the pyrohydrolysis pretreatment comprises: clamping a new sample boat with tweezers, laying a layer of asbestos on the bottom, then placing the sample boat on a sample disk of an automatic sampling system, grasping the sample boat into a sample chamber by an electric gripper, and pushing the sample boat by a push rod into a combustion tube of 1000-1100° C. for burning for 5-10 min for pyrohydrolysis treatment.

In some preferred embodiments of the present invention, the conditions of the pyrohydrolysis pretreatment comprise:
the oxygen flow of an inner tube of a combustion tube is 50-100 mL/min, the oxygen flow of an outer tube of the combustion tube is 50-200 mL/min, and the oxygen flow of blown cracking water is 50-200 mL/min; and a final constant volume is 10-50 mL, comprising 3-10 mL of absorption solution, 4-30 mL of cracking water and 3-10 mL of cleaning solution.

Preferably, the absorption solution and the cleaning solution are both aqueous ammonia with a mass concentration of 0.1-1%.

Preferably, the cracking water is I-grade experimental water.

In the present invention, samples such as rock, soil, water sediment, biological sample, petroleum, coal, plastic and semiconductor material can be used for the present invention.

The preheating and heating in the present invention are used for burning the organic matter in the substance to be determined. Those skilled in the art may choose to perform the preheating or not according to the content of the organic matter in the substance to be determined. In the present invention, the substance to be determined with large organic matter content is preheated, otherwise not preheated. The preheating of the present invention can make the organic matter in the substance to be determined burned before chlorine, bromine and iodine substances, to further reduce the possibility of deflagration. Under the same conditions, if the preheating is lower than 500° C., the combustion of the organic matter is incomplete and the combustion time is long, and if the preheating is higher than 600° C., the deflagration phenomenon is easy to occur, and the combustion tube is polluted.

In some preferred embodiments of the present invention, the workstation tuning parameters of the ICP-MS instrument in step (2) and step (3) are set as follows:
Re>2000;
In>40000;
U>30000;
CeO/Ce≤0.025;
Ce++/Ce≤0.04.

In some preferred embodiments of the present invention, the experimental parameters of the ICP-MS instrument in step (2) and step (3) comprise:
instrument mode: standard mode;
radio frequency power: 1500W;
plasma gas flow: 18 L/min;
auxiliary gas flow: 1.2 L/min;
atomizer gas flow: 0.96 L/min;
number of test points: 3;
sampling cone: platinum cone;
detection mode: peak jumping;
internal standard substance: rhodium;
internal standard adding mode: online adding of the internal standard solution;
atomizing chamber rubber ring: fluororubber.

The inventor of the present invention finds through research that, in the solutions of the above preferred experimental parameters, the mode of the ICP-MS instrument is a standard mode, that is, no gas is introduced into a collision reaction cell. Compared with the collision mode of kinetic energy discrimination (KED) (that is, helium is introduced into the collision cell of ICP-MS to make He collide with polyatomic interfering ions), the standard curve solutions of Cl, Br and I all have good linearity, the correlation coefficients of the standard curves have high accuracy, the measurement results are basically consistent, and the operation is simple without using helium, ammonia and other gases and is low in cost.

In some preferred embodiments of the present invention, the specific process of step (2) comprises:
(201) taking a chlorine single-element standard solution, a bromine single-element standard solution and an iodine single-element standard solution respectively, and preparing serial concentrations of standard curve solutions containing chlorine, bromine and iodine;
(202) taking the standard solution of an internal standard element and preparing an internal standard solution;
(203) injecting the serial concentrations of standard curve solutions into the ICP-MS instrument respectively, and determining the contents of chlorine, bromine and iodine using the internal standard solution by the online internal standard method to obtain the standard curves of the corresponding concentration value and the net strength value of each element.

Those skilled in the art may select serial concentrations of the standard curve solutions as required as long as the obtained standard curves facilitate subsequent accurate detection of the contents of chlorine, bromine and iodine.

It should be understood that the standard curve solutions of serial concentrations contain the same substance as the absorption solution, such as ammonia.

In some preferred embodiments of the present invention, the internal standard element in the internal standard solution is rhodium. The internal standard is used in the present invention, which can eliminate instrument drift and matrix effect, and the online addition of the internal standard can ensure that the contents of the internal standards in the standard curves and the measured sample are kept consistent to avoid the error of artificial addition. The inventor investigates the effects of three internal standards: In, Te and Rh. The research indicates that Rh as the internal standard has the best effect, and the recovery rate is always stable at 92-116%. Meanwhile, the results of 12 consecutive determinations of the sample are also very stable, which can significantly eliminate the signal drift of ICP-MS.

In some preferred embodiments of the present invention, the concentration of the internal standard element in the internal standard solution is 30-80 g/L.

In some preferred embodiments of the present invention, the concentration of chlorine in the standard curve solution is 500 μg/L-3000 μg/L, the concentration of bromine is 0.5 μg/L-100 μg/L, and the concentration of iodine is 0.1 μg/L-100 μg/L.

In step (203), preferably, obtaining the standard curves of the corresponding concentration value and the net strength value of each element specifically comprises: linearly fitting the detection data by taking the concentration values of the standard curve solutions of serial concentrations as the abscissa and the corresponding net strength values as the ordinate, to obtain the standard curves of the concentration values and the net strength values of chlorine, bromine and iodine respectively.

In step (3) of the present invention, preferably, further obtaining the contents of chlorine, bromine and iodine in the substance to be determined specifically comprises: the concentration c of chlorine, bromine and iodine in the obtained liquid is substituted into formula (1) below to calculate the content M of the element to be determined in the substance to be determined;

M=c*v/m×10⁻³ (1)

In the formula, M is the precipitation amount of the element to be determined in the substance to be determined, μg/g;
c is the concentration in the liquid to be determined, μg/L;
v is the constant volume of pyrohydrolysis, mL;
m is the weighing mass of the substance to be determined, g.

The method of the present invention combines pyrohydrolysis with ICP-MS, which makes the pretreatment simple, rapid and environmentally-friendly and can simultaneously and rapidly detect the contents of trace chlorine, bromine and iodine in the substance to be determined. The detection limit of the method is much lower than those of detection methods such as an ion selective electrode method, ion chromatography and colorimetry.

The present invention can simultaneously determine Cl of ppm level and Br and I of ppb level. In the traditional method, the ion chromatography is used for determining Cl, and determination of Br and I by ICP-MS needs multiple operations and is complicated in the steps and long in detection time.

The present invention will be further described in detail below in combination with specific embodiments.

### Embodiment 1

A method for simultaneous and rapid determination of chlorine, bromine and iodine by pyrohydrolysis combined with ICP-MS specifically comprises the following steps:

a. Treating a Sample Before Pyrohydrolysis:

### (1) Sample Boat and Asbestos Pretreatment

Treatment process: clamping a new sample boat with tweezers, laying a layer of asbestos on the bottom, then placing the sample boat on a sample disk of an automatic sampling system, grasping the sample boat into a sample chamber by an electric gripper, and pushing the sample boat by a push rod into a combustion tube of 1100° C. for burning for 5 min for pyrohydrolysis treatment. In the whole process, the oxygen flow of an inner tube of a combustion tube is 50 mL/min, the oxygen flow of an outer tube is 50 mL/min, and the oxygen flow of blown cracking water is 50 mL/min; and a final constant volume is 10 mL, comprising 3 mL of absorption solution which is aqueous ammonia with a mass concentration of 0.1%, 4 mL of cracking water which is I-grade experimental water, and 3 mL of cleaning solution which is aqueous ammonia with a mass concentration of 0.1%; and the pyrohydrolysis treatment is completed.

### (2) Soil Sample (One-Time Stepwise Heating):

Treatment process: clamping a pretreated sample boat with tweezers, weighing 0.1 g of sample with a scale and uniformly pouring into the sample boat, laying a layer of pretreated asbestos on the surface of the sample, placing the sample boat on a sample disk of an automatic sampling system, grasping the sample boat into a sample chamber by an electric gripper, pushing the sample boat by a push rod into a combustion tube for pyrohydrolysis treatment, heating at 700° C. for 3 min, and then pushing in for burning at 1100° C. for 20 min. In the whole process, the oxygen flow of an inner tube of a combustion tube is 50 mL/min, the oxygen flow of an outer tube is 50 mL/min, and the oxygen flow of blown cracking water is 100 mL/min; and a final constant volume is 20 mL, comprising 5 mL of absorption solution which is aqueous ammonia with a mass concentration of 0.1%, 10 mL of cracking water which is I-grade experimental water, and 5 mL of cleaning solution which is aqueous ammonia with a mass concentration of 0.1%; and the pyrohydrolysis treatment is completed. At this time, the solution in the collection bottle is the ICP-MS sample solution to be determined.

b. Drawing Standard Curves

Transferring standard solution A into a 100 mL volumetric flask, wherein every 1 L of standard solution A contains 1000 μg of bromide ions; transferring standard solution B into a 100 mL volumetric flask, wherein every 1 L of standard solution B contains 1000 μg of iodine ions; transferring standard solution C into a 100 mL volumetric flask, wherein every 1 L of standard solution C contains 1000 μg of chloride ions. Transferring 250 μL, 500 μL, 1500 μL, 2500 μL and 5000 μL of standard solution A, 25 μL, 50 μL, 500 μL, 1000 UL and 1500 μL of standard solution B and 40 μL, 50 μL, 100 μL, 125 μL and 150 μL of standard solution C respectively into a series of 50 mL volumetric flasks, adding 2.5 mL of aqueous ammonia with a concentration of 1 wt % respectively to the solutions, diluting with water to the graduation and uniformly mixing to obtain standard curve solutions of serial concentrations, wherein the concentrations of bromine ions are 5, 10, 30, 50 and 100 μg/L successively, the concentrations of iodine ions are 0.5, 1, 10, 20 and 30 μg/L successively and the concentrations of chloride ions are 800, 1000, 2000, 2500 and 3000 μg/L successively; each standard curve solution contains chlorine, bromine and iodine ions. Taking 5 μL of rhodium single-element standard solution (rhodium concentration is 1000 mg/L) into a 100 mL volumetric flask, diluting with water to the graduation and mixing uniformly to prepare an internal standard solution with a concentration of 50 μg/L. Injecting the above standard curve solutions of serial concentrations into an inductively coupled plasma mass spectrometry instrument, and determining the contents of chlorine, bromine and iodine by an online internal standard method.

Linearly fitting the detection data by taking the concentration values of different standard solutions as the abscissa and the corresponding net strength values as the ordinate, to obtain the standard curves of the concentration values and the net strength values of chlorine, bromine and iodine respectively.

c. Determining the Content of the Substance to be Determined in the Sample Absorption Solution

Starting the ICP-MS instrument and software; when the vacuum degree is less than 2.0×10⁻⁶ mbar, igniting the instrument; correcting a rectangular tube after the instrument is stabilized for 30 min; using the following workstation tuning parameters and experimental parameters of the ICP-MS instrument; and making the resolution, sensitivity, double charge, oxide, background and other parameters of ICP-MS meet the requirements of analysis.

The workstation tuning parameters of the inductively coupled plasma mass spectrometry instrument are set as follows:
Re>2000;
In>40000;
U>30000;
CeO/Ce≤0.025;
Ce++/Ce≤0.04.

The experimental parameters of the ICP-MS instrument are as follows:
instrument mode: standard mode;
radio frequency power: 1500W;
plasma gas flow: 18 L/min;
auxiliary gas flow (argon): 1.2 L/min;
atomizer gas flow (argon): 0.96 L/min;
number of test points: 3;
sampling cone: platinum cone;
detection mode: peak jumping;
internal standard substance: rhodium Rh;
internal standard adding mode: online adding of the internal standard solution;
atomizing chamber rubber ring: fluororubber.

The standard curves of chlorine, bromine and iodine measured through the internal standard method by different serial concentrations of standard curve solutions prepared in step b are determined at first. The equations and correlation coefficients of the standard curves are shown in Table 2.

TABLE 2

| Determined Element | Br | I | Cl |
|---|---|---|---|
| Standard Curve | y = 0.00108x | y = 0.02046x | y = 0.00023x |
| Equation | | | |
| Correlation | 0.999412 | 0.99972 | 0.999426 |
| Coefficient | | | |

Then, the concentration c of the sample solution to be determined obtained after pyrohydrolysis of the sample in step a is detected.

d. Analysis and Calculation

substituting the ion concentration value c measured above into the formula to calculate and analyze the content M of the element to be determined in the sample.

M=c*v/m×10⁻³ (1)

In the formula, M is the precipitation amount of the element to be determined in the substance to be determined, μg/g;
c is the concentration in the liquid to be determined, μg/L;
v is the constant volume of pyrohydrolysis, mL;
m is the weighing mass of the substance to be determined, g.

There is no deflagration phenomenon in the present embodiment. Different parallel samples are selected from the whole batch of samples of the embodiment for testing, and the specific test results of detection limits, determination lower limits and method accuracy are shown in Table 3.

### Embodiment 2

By referring to the method of embodiment 1, the differences are that in step a, biological sample rice is used instead of soil, and pyrohydrolysis treatment is conducted: firstly preheating at 500° C. for 5 min, then pushing in at 700° C. for 5 min, and then pushing in for burning at 1100° C. for 20 min; and other conditions are the same as those in embodiment 1.

The specific test results are shown in Table 4.

### Embodiment 3

By referring to the method of embodiment 2, the differences are that in the pyrohydrolysis treatment of the rice in step a, preheating time is 10 min, heating time is 10 min and burning time is 20 min.

The specific test results are shown in Table 4.

### Reference Example 1

By referring to the method of embodiment 2, the difference is that preheating is not conducted. Specifically, in step a, the biological sample rice is used for pyrohydrolysis treatment: heating at 700° C. for 10 min, and burning at 1100° C. for 20 min.

In the reference example, preheating is not conducted; a large amount of organic matter in the rice cannot be burned away; and the deflagration phenomenon occurs, resulting in a large amount of black carbon powder that flies out and adheres to the inner wall and the outlet of the combustion tube, a condensing tube and a constant volume pipeline, which will affect the measurement results. The experimental phenomenon and the test results are shown in Table 4.

### Reference Example 2

By referring to the method of embodiment 2, the difference is that the sample is not covered with asbestos in step a. The specific test results are shown in Table 4.

TABLE 3

| Sample No. | Br/μg · g⁻¹ | I/μg · g⁻¹ | Cl/μg · g⁻¹ |
|---|---|---|---|
| GBW07541 theoretical value | 11.2 ± 0.5 | 1.9 ± 0.3 | 574 ± 28 |
| Parallel sample 1 | 11.21 | 2.08 | 602.77 |
| Parallel sample 2 | 11.12 | 2.27 | 598.51 |
| Parallel sample 3 | 10.59 | 2.14 | 557.50 |
| Parallel sample 4 | 11.20 | 2.12 | 586.62 |
| Parallel sample 5 | 11.26 | 2.07 | 592.08 |
| Parallel sample 6 | 10.91 | 2.06 | 596.04 |
| Mean value | 11.05 | 2.12 | 588.92 |
| Standard deviation STD | 0.256 | 0.078 | 16.352 |
| Relative standard deviation RSD | 2.32 | 3.68 | 2.78 |
| Method detection limit (μg/L) | 0.12 | 0.03 | 24.93 |
| Method limit of quantitation (μg/L) | 0.41 | 0.11 | 83.10 |
| Method limit of quantitation (μg/g) | 0.082 | 0.022 | 16.62 |

TABLE 4

| | | Mean Value of Sample | | |
|---|---|---|---|---|
| | | Concentration Content | | |
| Sample Name | Experimental Phenomenon | Br/μg · g⁻¹ | I/μg · g⁻¹ | Cl/μg · g⁻¹ |
| GBW10010 | / | 0.56 ± 0.13 | 0.09 | 400 ± 40 |
| theoretical value | | | | |
| Embodiment 2 | No carbon powder is seen | 0.52 | 0.060 | 436.98 |
| Asbestos + 5 + 5 + 20 min | flying out, no deflagration | | | |
| Embodiment 3 | No carbon powder is seen | 0.58 | 0.067 | 428.54 |
| asbestos + 10 + 10 + 20 min | flying out, no deflagration | | | |
| Reference example 1 | Deflagration, resulting in a | 0.32 | 0.039 | 227.65 |
| Asbestos + 10 min + 20 min | large amount of black carbon | | | |
| | powder that flies out and | | | |
| | adheres to the inner wall and | | | |
| | the outlet of the combustion | | | |
| | tube, a condensing tube and a | | | |
| | constant volume pipeline | | | |
| Reference example 2 | No carbon powder is seen | 0.41 | 0.038 | 304.84 |
| No asbestos + 5 + 5 + 20 min | flying out, no deflagration | | | |

Note:
asbestos + 5 + 5 + 20 min means that asbestos is used for covering, and preheating, heating and burning are conducted successively for 5 min, 5 min and 20 min. The same for others.

It can be seen from the above results that, by adopting the solution of the embodiments of the present invention, the sample with high organic matter content is incinerated at 500° C. and then pushed into a moderate temperature region and a high temperature region to effectively prevent deflagration; at the same time, asbestos is added, which can prevent deflagration and sample spatter to a certain extent; and the detection values of chlorine, bromine and iodine are accurate, and the deviations are obviously smaller than that of the reference examples,

It can be seen from Table 4 that although no asbestos is added to the sample which is incinerated at 500° C. for 5 min, burned at 700° C. for 5 min and finally burned at 1100° C. for 20 min in reference example 2 and no carbon powder is seen flying out, Br and I contents are lower than those of the sample of embodiment 2 added with the asbestos under the same conditions, which proves that loss also occurs possibly because the sample is carried away by oxygen in the process of being loaded into the combustion tube.

The above describes the preferred embodiments of the present invention in detail, but the present invention is not limited to this. Many simple variations can be made to the technical solution of the present invention within the scope of the technical conception of the present invention, including the combinations of each technical feature in any other appropriate mode. These simple variations and combinations shall also be regarded as the disclosure of the present invention and belong to the protection scope of the present invention.

1. A method for simultaneous and rapid determination of chlorine, bromine and iodine by pyrohydrolysis combined with ICP-MS, comprising the following steps:
(1) placing a substance to be determined in a sample container, laying asbestos on the surface of the substance to be determined and then conducting pyrohydrolysis treatment;
wherein the process of the pyrohydrolysis treatment comprises: firstly, optionally, preheating for 3-10 min at 500-600° C., then heating for 3-10 min at 700-800° C. to burn off organic matter in the substance to be determined, and then burning for 10-30 min at 1000-1100° C.;
(2) preparing a standard curve solution and an internal standard solution of serial concentrations, and testing net strength using an ICP-MS instrument combined with an online internal standard method to obtain the standard curves of the corresponding concentration value and the net strength value of each element;
(3) testing the net strength of the liquid obtained in step (1) using the ICP-MS instrument combined with the online internal standard method, combining with the standard curves to obtain the concentrations of chlorine, bromine and iodine in the liquid, and further obtaining the contents of chlorine, bromine and iodine in the substance to be determined.

2. The method according to claim 1, further comprising: conducting pyrohydrolysis pretreatment for the sample container and the asbestos before step (1).

3. The method according to claim 2, wherein the process of the pyrohydrolysis pretreatment comprises: burning for 5-10 min at 1000-1100° C.

4. The method according to claim 1, wherein the conditions of the pyrohydrolysis treatment or the pyrohydrolysis pretreatment comprise:
the oxygen flow of an inner tube of a combustion tube is 50-100 mL/min, the oxygen flow of an outer tube of the combustion tube is 50-200 mL/min, and the oxygen flow of blown cracking water is 50-200 mL/min; and a final constant volume is 10-50 mL, comprising 3-10 mL of absorption solution, 4-30 mL of cracking water and 3-10 mL of cleaning solution.

5. The method according to claim 4, wherein the absorption solution and the cleaning solution are both aqueous ammonia with a mass concentration of 0.1-1%, and/or the cracking water is I-grade experimental water.

6. The method according to claim 1, wherein the workstation tuning parameters of the ICP-MS instrument in step (2) and step (3) are set as follows:
Re>2000;
In>40000;
U>30000;
CeO/Ce≤0.025;
Ce++/Ce≤0.04.

7. The method according to claim 1, wherein the experimental parameters of the ICP-MS instrument in step (2) and step (3) comprise:
instrument mode: standard mode;
radio frequency power: 1500W;
plasma gas flow: 18 L/min;
auxiliary gas flow: 1.2 L/min;
atomizer gas flow: 0.96 L/min;
number of test points: 3;
sampling cone: platinum cone;
detection mode: peak jumping;
internal standard substance: rhodium;
internal standard adding mode: online adding of the internal standard solution;
atomizing chamber rubber ring: fluororubber.

8. The method according to claim 1, wherein the specific process of step (2) comprises:
(201) taking a chlorine single-element standard solution, a bromine single-element standard solution and an iodine single-element standard solution respectively, and preparing serial concentrations of standard curve solutions containing chlorine, bromine and iodine;
(202) taking the standard solution of an internal standard element and preparing an internal standard solution;
(203) injecting the serial concentrations of standard curve solutions into the ICP-MS instrument respectively, and determining the contents of chlorine, bromine and iodine using the internal standard solution by the online internal standard method to obtain the standard curves of the corresponding concentration value and the net strength value of each element.

9. The method according to claim 1, wherein the internal standard element in the internal standard solution is rhodium, and/or the concentration of the internal standard element in the internal standard solution is 30-80 μg/L.

10. The method according to claim 1, wherein the concentration of chlorine in the standard curve solution is 500 μg/L-3000 μg/L, the concentration of bromine is 0.5 μg/L-100 μg/L, and the concentration of iodine is 0.1 μg/L-100 μg/L.

11. The method according to claim 2, wherein the conditions of the pyrohydrolysis treatment or the pyrohydrolysis pretreatment comprise: the oxygen flow of an inner tube of a combustion tube is 50-100 mL/min, the oxygen flow of an outer tube of the combustion tube is 50-200 mL/min, and the oxygen flow of blown cracking water is 50-200 mL/min; and a final constant volume is 10-50 mL, comprising 3-10 mL of absorption solution, 4-30 mL of cracking water and 3-10 mL of cleaning solution.

12. The method according to claim 3, wherein the conditions of the pyrohydrolysis treatment or the pyrohydrolysis pretreatment comprise:
the oxygen flow of an inner tube of a combustion tube is 50-100 mL/min, the oxygen flow of an outer tube of the combustion tube is 50-200 mL/min, and the oxygen flow of blown cracking water is 50-200 mL/min; and a final constant volume is 10-50 mL, comprising 3-10 mL of absorption solution, 4-30 mL of cracking water and 3-10 mL of cleaning solution.

13. The method according to claim 6, wherein the experimental parameters of the ICP-MS instrument in step (2) and step (3) comprise:
instrument mode: standard mode;
radio frequency power: 1500W;
plasma gas flow: 18 L/min;
auxiliary gas flow: 1.2 L/min;
atomizer gas flow: 0.96 L/min;
number of test points: 3;
sampling cone: platinum cone;
detection mode: peak jumping;
internal standard substance: rhodium;
internal standard adding mode: online adding of the internal standard solution;
atomizing chamber rubber ring: fluororubber.

14. The method according to claim 8, wherein the internal standard element in the internal standard solution is rhodium, and/or the concentration of the internal standard element in the internal standard solution is 30-80 μg/L.

15. The method according to claim 8, wherein the concentration of chlorine in the standard curve solution is 500 μg/L-3000 μg/L, the concentration of bromine is 0.5 μg/L-100 μg/L, and the concentration of iodine is 0.1 μg/L-100 μg/L.
